(19) United States
(12) Patent Application Publication
(10) Pub. No.: US 2012/0094672 A1
(43) Pub. Date: Apr. 19, 2012

(54) CELL EDGE COVERAGE HOLE DETECTION IN CELLEULAR WIRELESS NETWORKS

(75) Inventors: Rajaguru Mudiyanselage Mythri HUNUKUMBURE, Hillingdon (GB); Hui XIAO, West Drayton (GB); Luciano Pietro Giacomo SARPERI, Bern (CH)

(73) Assignee: FUJITSU LIMITED, Kawasaki-shi (JP)

(21) Appl. No.: 13/269,880

(22) Filed: Oct. 10, 2011

(30) Foreign Application Priority Data
Oct. 15, 2010 (GB) 1017456.3

(51) Int. Cl. H04W 36/30

(52) U.S. Cl. 455/436

(57) ABSTRACT

A cell edge coverage hole detection method based on collecting (S10) radio link failure, RLF, statistics provided by multiple UE reports at the handover stage. At a cell edge, the handover point varies for each UE due to the differences in parameter settings and measurement values, giving a statistical distribution of the exact handover point. In the method, RLF reports are grouped by connectivity pattern and a specific cell edge is identified for closer investigation (S20). Hysteresis and/or offsets are varied for UEs at the cell edge and subsequent RLF reports are monitored for changes in tendencies of event sequences (S30). If RLF persists for most of the UEs, the method infers from this (S40, S60) the existence of a coverage hole.

### CROSS REFERENCE TO RELATED APPLICATIONS

This application claims priority to United Kingdom Patent Application No. 1017456.3 filed on Oct. 15, 2010, the disclosure of which is expressly incorporated herein by reference in its entirety.

### FIELD OF THE INVENTION

The present invention relates to cellular wireless communication systems.

### BACKGROUND OF THE INVENTION

In current mobile systems such as CDMA or OFDMA based systems including 3GPP-LTE (LTE), WCDMA, and the WiMAX standards such as IEEE 802.16e-2005 and IEEE 802.16m, autonomous optimisation of the cellular network has become a major factor for operators as they look to reduce and even eliminate some of the burdensome costs associated with operating the network. With respect to the above mentioned technologies, one term applied to this type of network is a Self Organizing Network (SON). (Incidentally, in this specification, the terms “network” and “system” are used interchangeably except where a distinction is clear from the context).

In the early deployment stages of both LTE and WiMAX, for example, the subscriber count will be low thus making radio coverage the primary focus for operators as they dimension, plan, optimise and rollout their network. It is then normal practice, as subscriber count and demand gradually increase, that operators will shift their focus towards increasing capacity to the desired levels through additional radio planning and optimisation.

From early deployment to network maturity, operators spend a great deal of time and money maintaining key performance indicators (KPI's) through an optimisation process involving a number of radio planning engineers analytically evaluating drive test data collected from taking local measurements in an area of coverage problems and adjusting radio parameters in their planning/optimisation tools. These optimal parameters can then be exported to the appropriate network management entities within live networks responsible for holding and controlling network parameters such as, in LTE, the O&M (parameter holding entity) and EM entities (element management for base station control).

It would therefore be desirable to eliminate the above manual process, increasing the number of optimisations/parameter adjustments that are carried out autonomously/automatically (without human intervention) thus ultimately reducing operating expenditure (OPEX) of the network.

Self Organizing Networks (SON) is a promising solution to optimising the network performance while reducing the time and expense consumed by drive tests. The standardisation of SON features is a key part in Release 9 and Release 10 of the 3GPP LTE-A standards. Since coverage optimisation is a typical task for network optimisation, automated coverage hole detection (CHD), which is the prerequisite for coverage optimisation, has been acknowledged as a key feature of SON.

In cellular wireless systems, a coverage hole is an area in which the signal strength experienced by a mobile station (in this specification, the term “mobile station” and “user equipment” are used synonymously) is not sufficient to maintain basic connectivity, and there is no coverage from an alternative cell. Coverage holes can exist within a single cell, or in the vicinity of a border (or “cell edge”) between adjacent cells. At a cell edge, particularly if a mobile station is moving from one cell to an adjacent cell, a handover process is performed to attach the mobile station to a base station of an adjacent cell. However, handovers may fail for a number of reasons, as discussed below.

Coverage holes and failed handovers will potentially involve mobile stations experiencing Radio Link Failure (RLF) in which downlink and/or uplink coverage fails. A RLF occurs due to degradation of the air interface during an ongoing voice or a data service where generally, the physical layer detects a radio link failure when it becomes unsynchronised for instance.

The present invention relates in particular to coverage holes near cell edges and to ways of distinguishing radio link failures due to coverage holes from radio link failures having other causes during handover. Before proceeding further, it may be helpful to briefly outline a typical handover process in a wireless communication system with respect to FIG. 1. It should be emphasised that the following outline is simplified from the protocols actually employed in LTE and other practical wireless communication systems. Moreover, various forms of handover may be possible within the same wireless communication network; the one presented here is a typical example, sometimes called a “backward” handover, in which the source and target base stations co-operate to avoid loss of data and (as far as possible) ensure continuity of service.

As a simplified example, FIG. 1 shows a network with two base stations (eNodeBs, in LTE terminology) 20 and 30, each providing a coverage area or cell for mobile stations (referred to as UEs or user equipments in LTE), Cell A and Cell B respectively. Hexagonal cells are shown here for simplicity, although an LTE system for example may divide each hexagonal area into three cells served by the same eNodeB, and as will be understood by those skilled in the art, the coverage areas are not actually hexagonal in practice, but somewhat amorphous in shape, variable and overlapping.

As schematically shown here, Cell A and Cell B join at a cell edge AB. We assume that a mobile station 10 is located in the vicinity of this cell edge, is currently being served (has connectivity) in Cell A by base station 20, but is moving gradually further towards base station 30. In an LTE context, base station 20 would be referred to as the “source eNodeB”, and base station 30 as a “target eNodeB”. As indicated by arrows “a” in FIG. 1, the mobile station can receive signals from both base stations 20 and 30. The nature of such signals is not important, but for example each base station may send a periodic reference signal which the mobile station detects in order to determine some measure of received signal strength.

FIG. 2 shows the received strength of these signals “a”, as experienced by the mobile station 10, as a function of distance from Cells A and B. As the mobile station moves along the distance axis in FIG. 2, that is, gradually further away from base station 20 and towards base station 30, it will experience a gradually reducing signal strength from Cell A (see the left-hand curve in FIG. 2) and a gradually strengthening signal from Cell B (the right-hand curve in FIG. 2). The respective curves of signal strength cross over at a crossing point marked on the distance axis. In other words, at this point the signal strength from each base station is equal, and mobile station 10 may have connectivity with either cell.

In other words, it would now be possible for the mobile station 10 to “handover” from cell A to cell B. However, this does not occur immediately upon reaching the crossing point. Rather, the mobile station waits until the signal strength received from Cell B as measured by the mobile station (below, “neighbour cell measurement”), exceeds that of Cell A (“serving cell measurement”) by a certain margin. One reason for this margin is to avoid too-frequent handovers (called “ping-pong” handovers), particularly where the radio conditions are fluctuating or mobile stations move unpredictably relative to the base stations. Another reason is to prevent any interruption to applications having a high “Quality of Service” (QoS). That is, a wireless communication system such as LTE uses a so-called “hard” handover involving a brief loss of communication to the mobile station, which is undesirable in real-time applications such as streaming video.

The margin, referred to above, is depicted in FIG. 2 by the vertical arrow marked “hysteresis/offset”. The terms hysteresis and offset will be further explained below. There is another parameter, termed “timeToTrigger” in LTE systems, which is configurable to ensure the measurement report condition to be met for some duration. The example shown in FIG. 2 assumes that timeToTrigger is set as zero.

Assume now that the mobile station has moved closer to base station 30, such that its location corresponds to the point on the distance axis marked “trigger point”. At this point, the signal strength from cell B exceeds that from Cell A by the required margin, which triggers (directly or indirectly) the handover to cell B.

However, in LTE for example, the trigger point may not be the actual point of handover. Rather, the actual handover decision is taken by the base station 20 (eNodeB), guided by information from the mobile station 10 (UE). Thus, as indicated by arrow “b” in FIG. 1, the result of the mobile station reaching the trigger point is that it sends a measurement report to the base station 20 of Cell A, identifying the other base station 30 as one providing a sufficiently-higher signal strength. In other words the measurement report “b” identifies base station 30 as a target for handover. In response to this measurement report, base station 20 sends a handover (HO) request signal “c” (not necessarily wirelessly) to base station 30 to prepare it for the handover. Meanwhile, a HO command “d” is sent from the base station 20 to the mobile station; the timing of this command (and corresponding location of the mobile station) may be regarded as the handover decision point. For convenience, however, the trigger point shown in FIG. 2 may also be treated as a handover point.

The UE performs synchronisation to the target eNodeB and access the target eNodeB via RACH (Random Access CHannel) procedure. When the access to the target cell is complete, the UE issues a RRCConnectionReconfigurationComplete message to confirm the handover. This message is received by the target cell (which has now become the source). This indicates the completion of the HO procedure from the radio access point of view. Such a successful handover allows the mobile station to continue communication with the minimum of interruption to service and minimum overhead on the network. Not every handover is successful, however; as discussed in more detail below, handover may be attempted too early or too late with respect to the target cell, causing RLF. These are called “(pure) handover issues” below. A failed handover may involve interruption of service, loss of data and/or the need to re-transmit data from or to the network.

Cell edge is a particularly difficult region for coverage hole detection. The result of a coverage hole will be RLF and at cell edge, a common cause of RLF would be handover issues. Hence coverage holes can easily be interpreted as handover failure at cell edge. Within this context, it is important to have robust methods which can distinguish between coverage holes and handover failure issues at the cell edge. Clearly, where RLF reports provide an accurate indication of a UE's location, it is easier to locate a coverage hole. However, with respect to

LTE for example, the requirement for accurate UE location information is optional for release 8 and 9 of LTE and in this context it would be highly desirable to provide an automated coverage hole detection method which does not rely on location information.

### SUMMARY OF THE INVENTION

According to a first aspect of the present invention, there is provided a method of detecting coverage holes in a wireless communication network, the wireless communication network comprising a cell in which radio links are defined with a plurality of user equipments, the cell bordered by other cells at respective cell edges, the network operable to handover a said user equipment at a said cell edge when predetermined handover parameters are fulfilled to define a new radio link, the method comprising: collecting reports indicative of radio link failure from the user equipments and identifying a specific cell edge at which such reports occur; for user equipments at the specific cell edge, varying the handover parameters and observing the effects, if any, of said varying on the occurrence of subsequent reports indicative of radio link failure; and distinguishing radio link failures caused by a coverage hole from radio link failures having other causes, based on the observed effects of varying the handover parameters.

In the above method, preferably, the varying (e.g., varying step or action) includes varying the values of at least one of a hysteresis and an offset applied to a threshold of a parameter relating to signal strength and/or quality, the threshold triggering a measurement report from the user equipment.

More particularly, the varying may include at least one of reducing and increasing the hysteresis and/or offset value applied to user equipments at the cell edge, within a permissible range of values. This may be done in a series of value changes, preferably starting with a small change to avoid unwanted effects on users. The number and size of changes may be increased until sufficient data has been gathered.

The reports indicative of radio link failure include can one or more of: reports generated in response to an unsuccessful handover which include information indicative of an event sequence related to the unsuccessful handover; and reports generated shortly before or after a successful handover, which include information indicative of an event sequence related to the successful handover. Here, unsuccessful handovers include cases in which the handover process was initiated (HO measurements available) but unsuccessful, as well as cases in which the handover process was not initiated (no HO measurements available) due to some reason.

In this case, the distinguishing comprises determining whether, for one or more distinct handover event sequences, related reports become more or less frequent subsequent to the varying. This is because certain possible event sequences (particularly, location-dependent ones) are more affected by coverage holes than other (time-dependent) sequences.

In the above method, preferably, the collecting also includes collecting hysteresis and/or offset values set in the user equipments generating reports indicative of radio link failure. The collecting also preferably includes collecting measurement reports used in handover. RLF reports and measurement reports used for HO are collected by the eNodeB from UEs, and then these are sent to the SON server (see later) by the eNodeB together with the hysteresis and/or offset values which are already known to the eNodeB. RLF reports and measurement reports can help the SON server to identify a specific cell edge where the RLF reports occur.

The reports indicative of radio link failure may indicate the radio link failure either directly or indirectly. For example, when the method is applied to a LTE-based network, the reports indicative of radio link failure may include at least one of an RLF report (in other words a direct report) and an RRC Connection Reestablishment Request (an indirect report). Such a Request is sent by a UE in an LTE network when it has lost its connection with its serving cell and has identified a cell (which may be the same cell or a different cell) with which to connect.

In the above method, the parameter relating to signal strength and/or quality includes at least one of a Reference Signal Received Power, a Reference Signal Received Quality, a Received Signal Strength Indicator, and a Carrier to Interference plus Noise Ratio.

When the method is applied to an LTE-based network in which the cells are provided by eNodeBs, at least the collecting and the varying involve the eNodeBs. However, the eNodeBs will normally be supervised by a higher-level entity in the network. Thus, in one embodiment, the eNodeBs send the results of the collecting to a SON server in the network, the varying is performed by the SON server instructing the eNodeBs, and the observing and the distinguishing are performed by the SON server.

According to a second aspect of the present invention, there is provided a wireless communication system arranged to perform any method as defined above.

According to a third aspect of the present invention, there is provided an eNodeB for an LTE-based wireless communication network and configured for use in any method defined above.

According to a fourth aspect of the present invention, there is provided a SON server for use in the method. The SON server may be a general-purpose computer executing a SON algorithm written in software.

In any of the above aspects, the various features may be implemented in hardware, or as software modules running on one or more processors.

The software may be provided in the form of a computer program product, such as a computer readable medium having stored thereon a program for carrying out any of the methods described herein. A computer program embodying the invention may be stored on a non-transitory computer-readable medium, or it could, for example, be in the form of a signal such as a downloadable data signal provided from an Internet website, or it could be in any other form.

Features and preferable features of any and all of the above aspects may be combined.

### BRIEF DESCRIPTION OF THE DRAWINGS

Reference is made, by way of example only, to the accompanying drawings in which:

FIG. 1 schematically illustrates handover between two cells A and B in a wireless communication network;

FIG. 2 is a graph of curves of received signal strength and distance for a UE near a cell edge between cells A and B;

FIG. 3 is a graph similar to FIG. 2 but showing a range of curves for different UEs;

FIG. 4 is a graph illustrating a Scenario I coverage hole;

FIGS. 5 (a) to (d) show event sequences experienced by UEs attempting handover from cell A to cell B;

FIG. 6 shows the expected effects of reducing hysteresis and/or offsets for cell-edge UEs undergoing handover;

FIG. 7 shows the expected effects of increasing hysteresis and/or offsets for cell-edge UEs undergoing handover;

FIG. 8 is a graph illustrating a Scenario II coverage hole;

FIG. 9 shows a possible event sequence in the case of a Scenario III;

FIG. 10 is a graph illustrating a Scenario III coverage hole;

FIG. 11 is a graph illustrating the effect of adjusting handover decision points in Scenario III;

FIG. 12 is a graph showing the effect of measured signal strength of a coverage hole; and

FIG. 13 is a flowchart of a method embodying the present invention.

### DETAILED DESCRIPTION

In the following, the 3GPP LTE system is used as a background to present an embodiment of the present invention. However, it should be noted that LTE system serves purely as an example and the invention could be applied to any other wireless networks, for example IEEE 802.16m (WiMAX) or others.

The present inventors have examined the nature of cell edge handover execution with particular reference to LTE, and devised a methodology to distinguish handover failure from possible coverage hole issues.

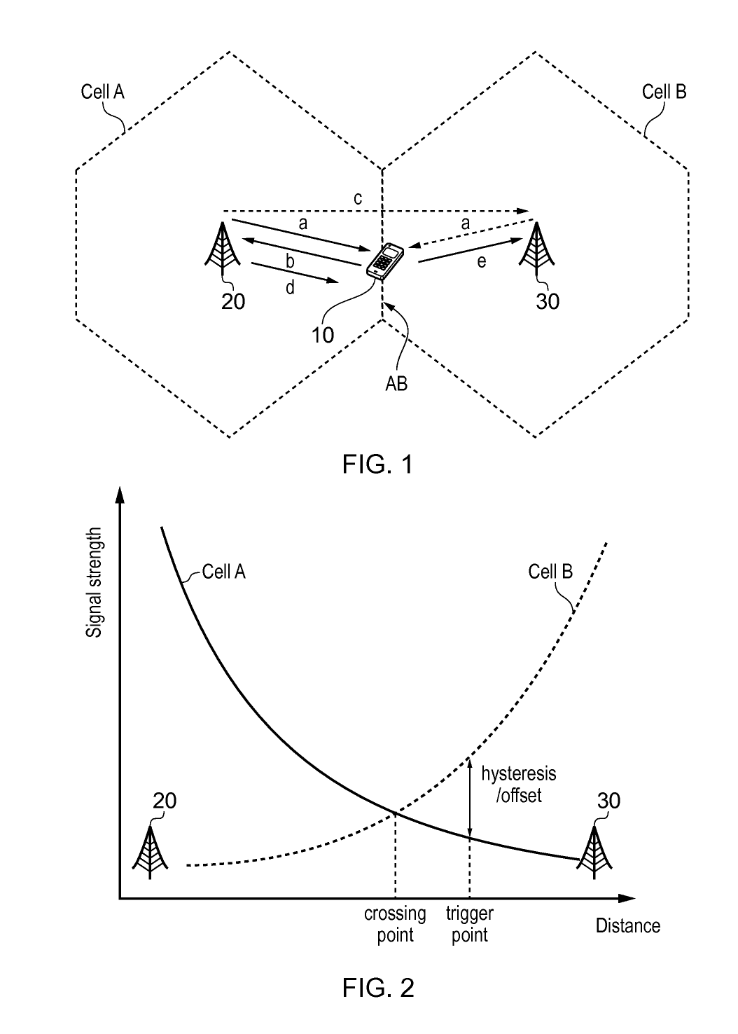

In the LTE handover procedure, which in simplified terms has already been discussed with respect to FIGS. 1 and 2, the source eNodeB configures the measurement procedures for a UE with measurement control messages. These messages include specific thresholds (including offsets) in signal strength that should be fulfilled for the UE to provide a measurement report (message “b” in FIG. 1). Once the reporting conditions are fulfilled, the UE transmits measurement reports to the source eNodeB. The source eNodeB will initiate the handover process by sending the HO request to a target eNodeB identified in the measurement reports.

A common trigger for measurement reports to be transmitted to the source eNodeB is a so-called A3 event, which is satisfied when the neighbour cell measurement plus cell and frequency specific offsets minus a hysteresis becomes larger than the serving cell measurement plus cell and frequency specific offsets plus a user specific offset. The user specific offsets help to differentiate the service quality provided to each user. For example, a UE requiring a higher QoS would have higher offsets to ensure that it does not suffer from ping-pong effects at handover. The hysteresis value is also changeable per specific user.

Meanwhile, the measured signal strengths for two UEs in a similar location will not be identical. The RSRP (Reference Signal Received Power) is an average signal strength measurement and it will vary due to variations in the instantaneous measurements and measurement error. RSRP is an absolute signal power measurement in dBm (i.e. absolute) units. An alternative is RSRQ, which is Reference Signal Received Quality; this is a relative power measurement (or signal quality measurement) considering the interference from neighbour cells as well. This measurement is done in dB (i.e. relative) units. Accordingly, in this specification, the expression “signal strength” covers both absolute and relative measures of signal strength.

Due to the above effects, the HO decision point on the relative signal strength graph will vary for individual UEs.

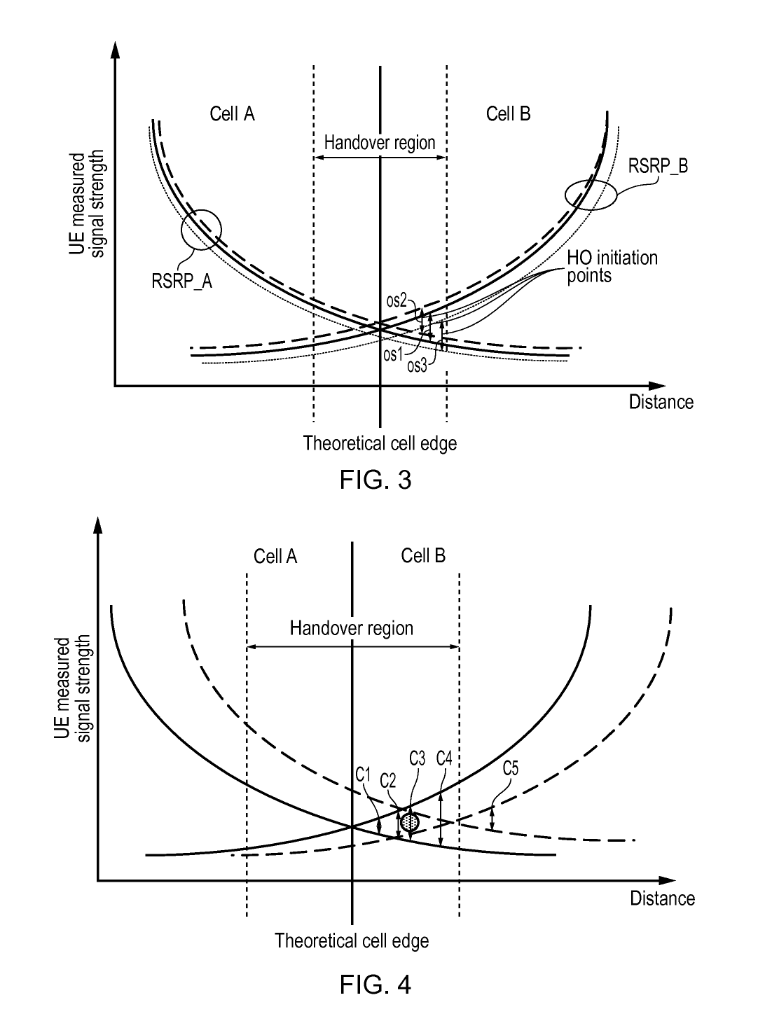

That is, as shown in FIG. 3, the measured signal strength curves (collectively denoted RSRP_A for Cell A and RSRP_B for Cell B) and the individual offset/hysteresis values will vary for each UE and this will give a distribution of handover points for the UEs travelling from cell A to cell B. The user specific offsets and hysteresis are denoted by os1, os2 and os3 in FIG. 3. The scenario for UEs travelling in the opposite direction (in other words those UEs with a connectivity pattern from Cell B to Cell A) will be same. Hence there will be a collective handover region, as shown by the portion of the distance axis between dashed lines in FIG. 3.

A key insight made by the inventors is that if a coverage hole falls within the handover region (as shown in FIG. 3), by observing RLF reports (see below) by UEs and tracing their measurement results and offset values, it should be possible to detect the coverage hole. When a RLF is repeatedly reported from a specific cell edge, it is normal for the eNodeBs to change the offset values to try and solve the RLF issue. If the RLF is due to a handover issue, changing the offsets (i.e. measurement configuration) should solve the handover problem. Initially the occurrence of RLF events may go up due to wrong parameter settings, but as the tuning becomes more accurate, the RLF events should become negligible. Conversely, if a constant residue of RLF events is observed for the whole range of possible offset (and hysteresis) values, then it could be positively detected that a coverage hole exists in that particular cell edge. Changing the hysteresis and/or offsets in this way is referred to below as “tuning”.

The following embodiment presents one possible way for tuning the HO parameters (offset and hysteresis) to detect the existence of coverage hole problem for a specific cell edge. Instead of tuning HO parameters to solve the RLF problems caused by inappropriate HO settings, the method embodying the present invention aims at detecting whether the RLF events at a particular cell edge are purely due to HO issues or have something to do with coverage hole problems. The basic idea of the method is that it analyses the difference in probability of occurrence for each kind of RLF event sequence before and after tuning HO parameters. The rationale is that the change in occurrence probability, before and after tuning HO parameters for certain RLF event sequences, due to pure HO issues is different from that due to coverage hole problems or due to the combination of HO issues and coverage hole problems. If RLF events are only due to HO issues, then an HO optimization procedure should be applied to solve the RLF problems. Otherwise, the existence of coverage holes is inferred and needs to be fixed by coverage hole compensation methods.

Three possible scenarios of coverage holes at the cell edge between cell A and cell B will now be presented.

### Scenario I

As shown in FIG. 4, in this scenario, the coverage hole (schematically represented by a shadowed circle) is located at the boundary between cell A and cell B, but it is within cell B.

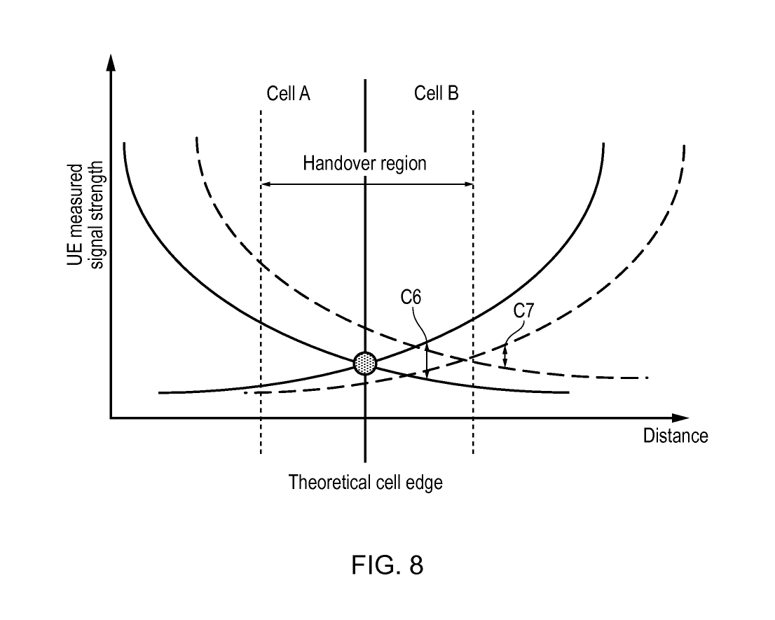

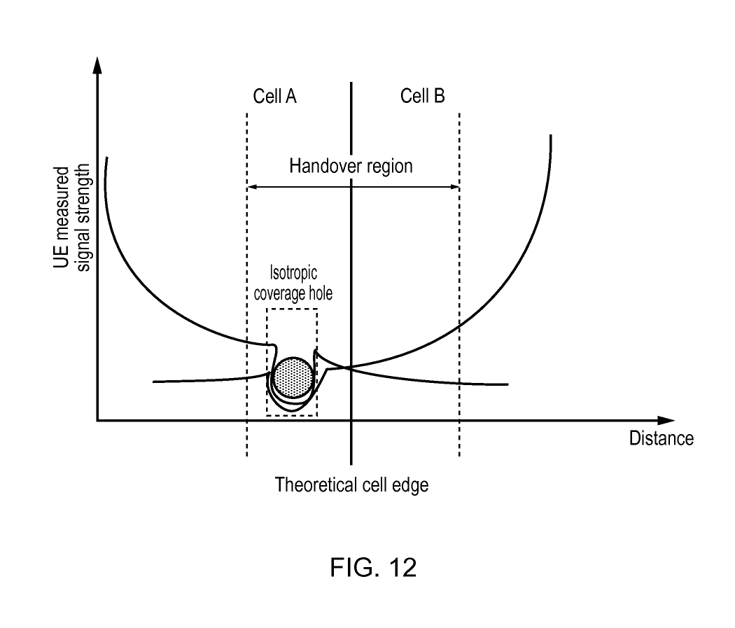

Incidentally, in FIGS. 4, 8 10, and 11, the measured signal strength curves at the coverage hole area represented by the shadowed circle should actually have severe degradations. For simplicity, the shadowed circle is used to implicitly denote this. Please refer to FIG. 12 for the explicit presentation of coverage hole area in terms of the measured signal strength.

As before, it is assumed that UEs migrate from Cell A to Cell B. For now, this single connectivity pattern will be considered even though, as will be appreciated, in a real system UEs may move among several mutually-adjacent cells in different directions so that many different connectivity patterns may exist.

In FIG. 4, the solid lines stand for a set of measured signal strength curves at the cell edge for some UEs. Cases C1 to C4 represent the HO decision points before tuning the HO parameters, employing four different HO settings (offset and hysteresis) for this set of measured signal strength curves. They in turn represent the cases that the HO decision point is long before (“before” in the sense of located less far along the distance axis), just before, in the middle of and after (“after” in the sense of located further along the distance axis) the coverage hole, respectively. It is assumed that once the HO decision is made by the source eNodeB, the target eNodeB can accept the HO request to enable the HO command to be delivered from the source eNodeB to the UE; here, we actually regard the HO decision point as the time point when the UE receives the HO command as well. The dashed lines represent another set of measured signal strength curves at the same cell edge for some other UEs. They are shifted from the solid lines because of the existence of measurement error. Case C5 represents the HO decision point in the case that the measured signal strength curves have such kind of shifts.

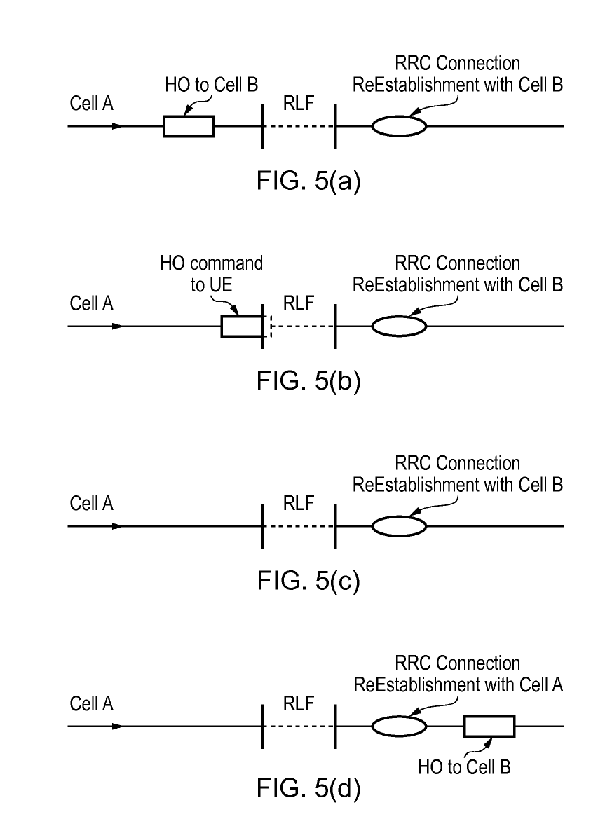

It is possible to define various possible “event sequences” for UEs undergoing handover, whether successful or not, which involve a radio link failure at some point. For Cases C1 to C5, the event sequences experienced by UEs are shown in FIGS. 5 (a) to (d) where FIG. 5(a) represents C1, FIG. 5(b) is C2, FIG. 5(c) shows cases C3 and C4, and FIG. 5(d) shows C5. Note that in each case, the existence of the coverage hole results in an RLF event, the effect and severity of which depends on how far the handover sequence has progressed. In FIG. 5(a) for example, the handover has already been made prior to the UE reaching the coverage hole so that the UE is already connected to Cell B and needs to reconnect with Cell B after passing through the coverage hole. By contrast, in FIG. 5(d) the coverage hole is encountered before handover so that on emerging from the coverage hole the UE has to reconnect with Cell A.

As already mentioned, the decision to issue a HO command depends on the measurements provided by the UEs. In cases C4 and C3, the RLF happens before and just at the point of UE measurements satisfying the above-mentioned A3 condition for HO. After RLF when the UE tries to re-establish the connection, Cell B has the stronger signal so in these cases the UE connects to Cell B without HO (which will involve loss of any data waiting at the source eNodeB). In C5, after RLF the cell A still has the stronger measured signal, so UE re-connects to cell A and then the A3 condition is satisfied for HO. In all cases, it is assumed that the UE can move out of the coverage hole in time to allow a successful RRC Connection ReEstablishment after the RLF.

Cases C1 to C5 may be regarded as event sequences resulted from coverage hole problems. However, as already mentioned, radio link failure can also occur for reasons other than a coverage hole, for example inappropriate HO settings can make cell-edge UEs suffer from radio link failures, which can be typically categorized into too late and too early handover problems. In the case of too late HO, a failure occurs in the source cell before the HO was initiated or during the HO procedure; the UE attempts to re-establish the radio link connection in the target cell. In the case of too early HO, a failure occurs shortly after a successful handover from a source cell to a target cell or during a handover; the UE attempts to re-establish the radio link connection in the source cell.

The event sequences upon RLF due to pure Too Late and Too Early HO issues are as follows:
T1: Too Late HO
Cell A→No HO command→RLF→RRC Connection ReEstablishment with Cell B
T2: Too Early HO. Two sub-sequences exist:
T2.1: Cell A→HO command to UE→Successful HO→RLF→RRC Connection ReEstablishment with Cell A
T2.2: Cell A→HO command to UE→Unsuccessful HO→RLF→RRC Connection
ReEstablishment with Cell A.

Comparing the above event sequences with FIG. 5, it can be seen that the event sequence for Case C3 and C4 can be confused with the phenomenon observed upon RLF due to Too Late HO.

As already mentioned, in a practical system an individual cell may have cell edges with a number of other cells. If at a specific cell edge the RLF event sequences observed include a combination of T1 and T2, or sometimes even the combination among C1 to C5, T1 and T2, then tuning the HO settings in the following way can help examine whether there exist coverage hole problems in the vicinity of that cell edge.

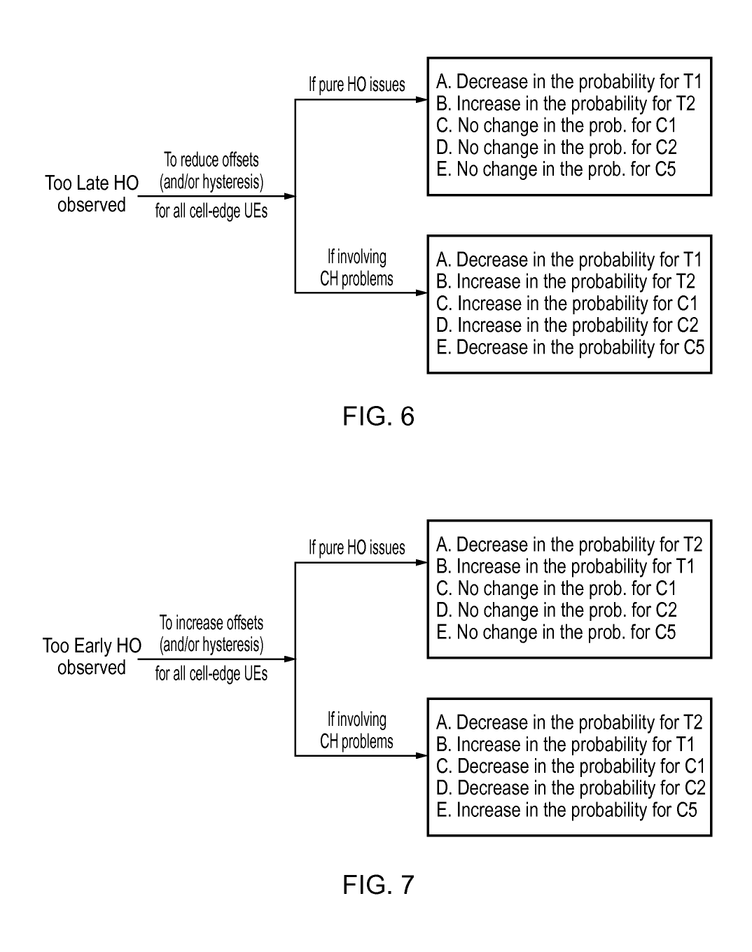

Firstly, if T1 (Too Late HO) is observed, then by a first action of reducing HO offsets (and/or hysteresis) for all the cell edge UEs, the expected effects are as shown in FIG. 6. Secondly, if T2 is observed, then by a second action of increasing the hysteresis and/or offsets for all the cell edge UEs, the expected effects are as shown in FIG. 7.

In each case, the effects depend on whether the RLFs are due to a coverage hole (CH), or other causes (so-called “pure-HO issues”). Taking the first possibility (item A) shown in FIG. 6 as an example, “Decrease in the probability for T1” means a diminished likelihood that, subsequent to reducing the hysteresis and/or offsets, further RLF reports will be a result of a T1 (Too Late HO) event sequence. On the other hand (item B), it is expected that T2 (Too Early HO) event sequences will become more likely because, other things being equal, reducing hysteresis and/or offsets will make HO occur sooner. This will be the case regardless of whether RLFs are due to pure HO issues, coverage holes, or a mixture of both. On the other hand, if RLFs are due to pure HO issues, there will be no change in the occurrence of event sequences C1, C2 or C5, whilst the existence of a coverage hole will result in these probabilities changing also, as set out in the lower right-hand part of FIG. 6. That is because a reduced hysteresis and/or offsets will lead to HO decisions being shifted to the left-hand side of the distance axis in FIG. 4.

Likewise, in FIG. 7, the action to increase the hysteresis and/or offsets where pure HO issues are involved will likely decrease the occurrences of RLF due to Too Early HO (T2) whilst increasing them for Too Late HO (T1), because HO decisions will tend to occur later. Meanwhile there should be no effect on RLFs due to a coverage hole. On the other hand, existence of a coverage hole is expected to result in the additional effects that C1/C2 become less likely and C5 more likely, the later HO decision translating into a location further along the distance axis of FIG. 4 with respect to the coverage hole.

Since event sequences C3/C4, caused by coverage hole problems, are difficult to distinguish from T1 which is due to HO issues, and have the same changing tendency as that of T1, C3/C4 are not explicitly included in FIGS. 6 and 7, the changing tendency of which can be implicitly covered by that of T1. Upon tuning the HO settings, item A in FIG. 6 and item B in FIG. 7 may be observed happening but it might not be possible to judge whether they are purely due to HO issues or coverage hole problems. Consequently, items C, D and E in FIGS. 6 and 7 (or one/some of these items) are regarded as especially useful to examine the existence of coverage hole problems.

It is possible to employ the first action (FIG. 6, reducing hysteresis and/or offsets) or the second action (FIG. 7, increasing hysteresis and/or offsets) or the combination of both to examine the existence of coverage hole problems at a specific cell edge. Changing hysteresis and/or offset values in a series of small steps in either direction (increasing or decreasing) can help obtain a good trade-off between detecting the existence of CH and degradation of the user's experience. For example, by reducing the values it is more possible to observe items C, D and E or one/some of them when there is a CH problem; however, UEs that do not pass through the CH area are more likely to suffer from too early HO (T2). Therefore, it is preferable to adjust the parameter step by step to get a good balance between observing the changing tendency of certain event(s) and the unnecessary degradation caused to UEs that are originally not affected by CH problem. Both increasing and decreasing the hysteresis and/or offsets are equally effective.

There may be little to choose in practice between altering hysteresis, offset, or both, as it is their combined effect which it is important. The hysteresis value makes the entering and leaving conditions for the A3 event slightly different. In effect it prevents ping pong effects if there are RSRP (or RSRQ) fluctuations around the A3 trigger point. So it can be changed to move the HO point back and forth. But care should be taken not to reduce it too low, as this would cause ping pong HOs.

In an LTE system, the permissible range for hysteresis is 0-15 dB, and it is −15 to +15 dB for offset. By using both, the adjusting range is larger; however, it is not necessary for both to be altered at the same time. Additionally, for a system that has UEs with advanced features, for example, to provide the location information preceding the RLF, the system can configure a subset of cell edge UEs that will go through the suspicious area.

As already mentioned, having identified a specific cell edge of interest for detection of a coverage hole, normally all UEs near or (if the required information is available) heading towards that cell edge would be selected for tuning the hysteresis and/or offsets; these UEs are selected as per the RLF reports. From the RSRP (or RSRQ) reports of neighbour cells it can be estimated which cell edge the UEs is at (or heading to) and if there is a history of RLFs at the cell edge, then the suggested offset changes can be executed.

### Scenario II

The coverage hole is located at the boundary between two cells. FIG. 8 demonstrates this coverage hole scenario. Based on what has been explained for Scenario I, the event sequences for Case C6 and C7 are the same as those for C3/C4 and C5 respectively.

Therefore, by tuning the HO settings, we can obtain the same changing tendencies for different event sequences as those shown above. Thus the existence of coverage hole problems at a specific cell edge for this scenario can also be detected.

### Scenario III

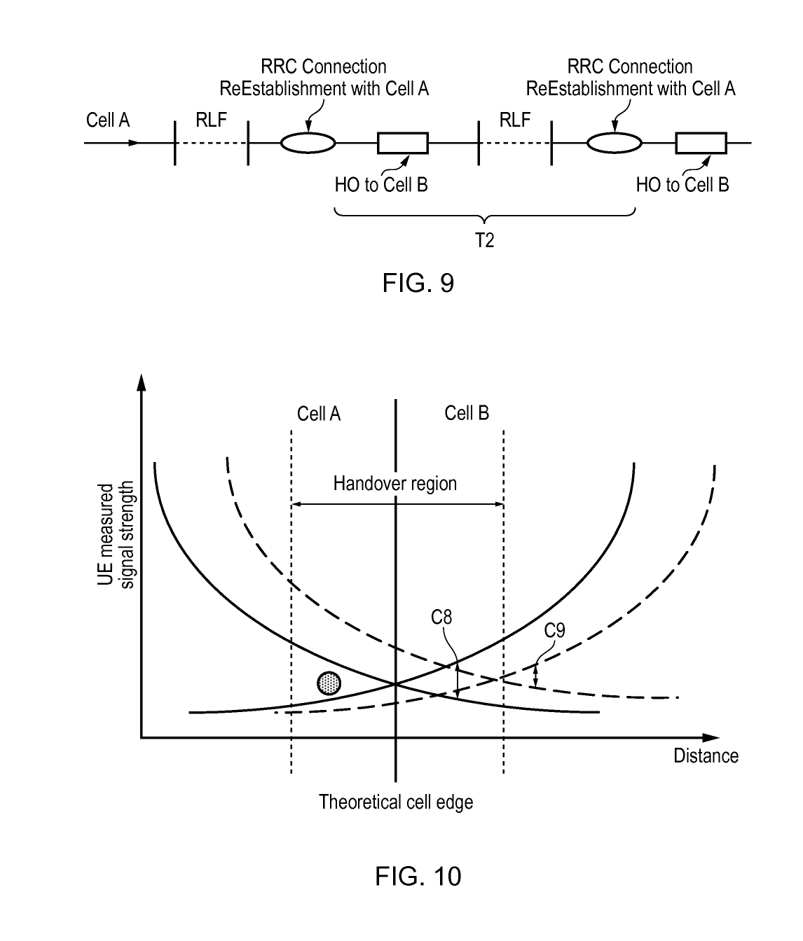

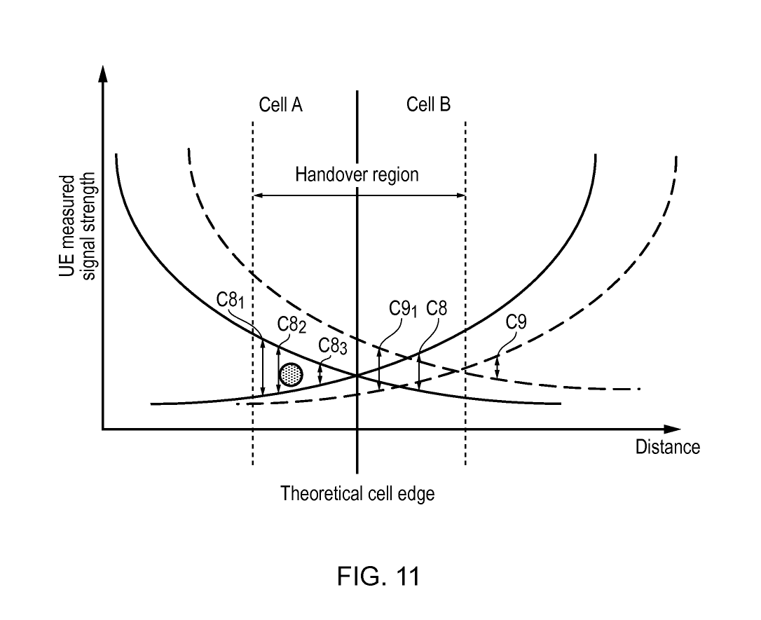

In this Scenario, the coverage hole is located close to the cell boundary but within cell A. FIG. 10 demonstrates the basic coverage hole scenario, and FIG. 11 shows modified location-based event sequences which may occur upon adjusting the hysteresis and/or offsets in the Scenario. FIG. 9 shows event sequences C83 and C91 (see below) which can arise in this instance.

As has been explained for Scenario I, the event sequences for Case C8 and C9 are the same as that for C5.

Recall that the “crossing point” on a graph like FIGS. 10 and 11 means the point where corresponding signal-strength curves of two cells intersect. When decreasing the HO offsets (and/or hysteresis) for all the cell edge UEs (see FIG. 11), the event sequences experienced by the UEs are as follows: the event sequence is the same as C5 when the HO decision points (C8 and C9) are moved towards the crossing point but still at the right-hand side of the crossing point; when decreasing the HO offsets (and/or hysteresis) to the left-hand side of the crossing point but still within the handover region, the event sequence is T2.1 with C5 when adjusting the HO decision point from C8 to C81; the event sequence is T2.2 when adjusting C8 to C82; the event sequence is the FIG. 9 event sequence when adjusting C8 to C83 or adjusting C9 to C91. Here C81, C82 and C83 denote the HO decision point that is long before, right before and after the coverage hole respectively, and C91 denotes the case that the HO decision point is moved to the left-hand side of crossing point within the UE's HO region, but it is still after the coverage hole area. A 2^{nd} RLF can occur because the HO was prompted too early, due to decreasing the HO offsets which are originally at the positions of C8 and C9 but are moved to the HO region at the left-hand side of the crossing point when decreasing them; thus, the second RLF is not due to CH.

However, this event sequence contains the Too Early HO (T2.1) sequence explained in Scenario I. Note that instead of the shown subsequent HO to Cell B an RLF event in Cell A with RRC Connection Reestablishment with Cell B would be possible. Therefore the possibility for T2 will increase when reducing the HO offsets (and/or hysteresis) for all the cell edge UEs, and the possibility for C5 will decrease, because sometimes C5 event sequences can become T2 event sequences, and sometimes C5 can become the new C8₃/C9₁ event sequences (each of which also includes T2). So the same changing tendencies for T2 and C5 event sequences as expected in Scenario I are obtained for this scenario and the detection method in Scenario I can also be applied to this scenario.

### Multiple Coverage Holes

In case of multiple coverage holes, a combination of the effects described in the Scenarios I, II and III will be observed. Since the effect of modifying the HO offsets (and/or hysteresis) for the UEs are consistent for all Scenarios, it can be concluded that this invention will also be applicable to such a case, since a combination of the effects belonging to different scenarios will be observed.

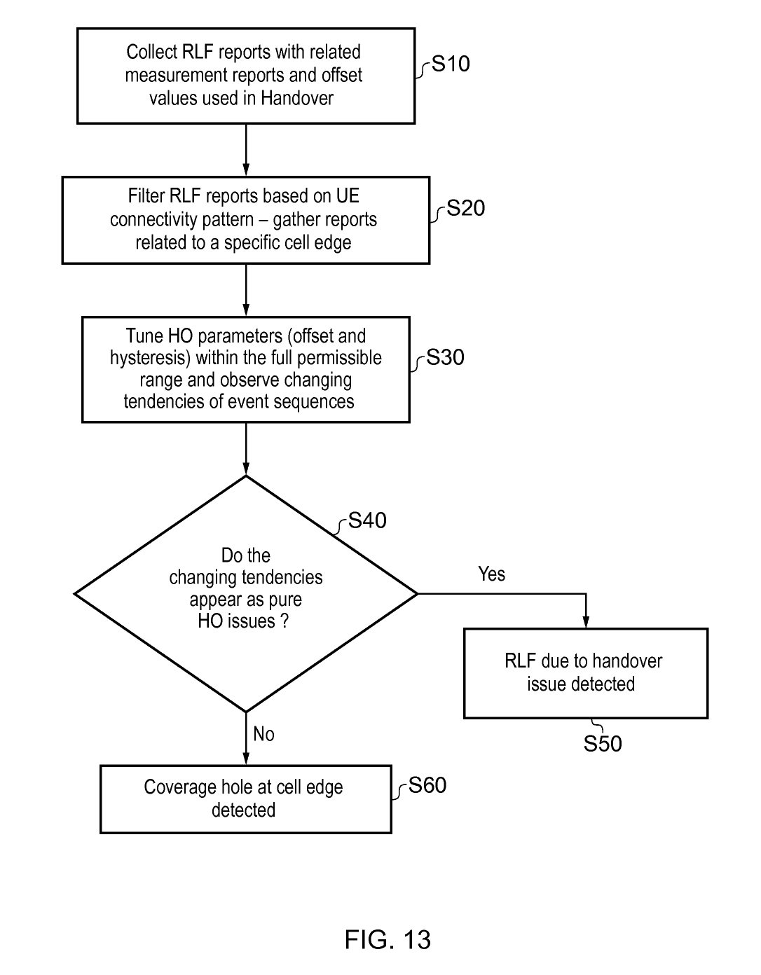

FIG. 13 is a flowchart showing how eNodeBs and a SON entity may autonomously carry out a method embodying the present invention. It should be noted that, although the flowchart shows actions performed in the method of the invention as a sequence of steps, it is not necessarily essential that these actions be performed strictly in sequence or only one at a time.

In a first step S10, the eNodeB collects RLF reports (direct or indirect, see below) from UEs with which it is connected. The SON server collects RLF reports with related measurement reports and hysteresis and offset values used for HO. The SON server gathers all the information (S20) and uses the RLF reports and measurement reports, which imply the connectivity patterns of UEs, to identify a specific cell edge. That is, the cell edges for a hexagonal cell will have 6 boundaries connecting the source cell to different neighbour cells, and by considering the connectivity patterns from source cell A to a specific neighbour cell B, it is possible to identify the specific cell edge at which RLFs are occurring and which might be harbouring a coverage hole problem. The RLF reports preferably include information allowing an event sequence to be extracted, or this may be inferred from information previously given by the UE.

The next step (S30) is to tune the hysteresis and/or offsets of UEs at a specific cell edge using the methodology explained below and to observe the effects. The SON server can instruct the eNB how to vary the hysteresis and/or offset values according to the collected information (which can include RLF reports, measurement reports, and hysteresis and offset values).

In other words, RLF reports subsequent to tuning are observed for a time sufficient to observe a change in tendencies of event sequences at a certain cell edge. This step may need to be repeated a number of times, altering the hysteresis and/or offsets by differing amounts (and perhaps in different directions) each time, and collecting subsequent RLF reports with related measurement reports and hysteresis and offset values, until sufficient information has been gathered. Because the SON server supervises multiple eNBs, each time after tuning the HO parameters (S30), S10 and S20 need to be repeatedly done at the SON server. It is preferable to vary the hysteresis and/or offsets in small steps at least to begin with, to avoid affecting UEs HO behaviour unfavourably.

Thus, steps S10 to S30 are mainly performed by the SON server with the help of eNBs. Once sufficient information has been gathered, the SON server makes a judgement as to whether the change tendencies for particular event sequences leading to RLF are as would be expected due to “pure” HO issues, or in other words due to T1 or T2-type events (S40). If Yes, it is judged (S50) that RLFs are due to handover issues. If not (S60) it is judged that a coverage hole is present, which may require further action by the SON server.

It should be noted that RLF reports are only one mode of identifying radio link failure. If RLF reports are not available, RRC Connection Reestablishment Requests or other methods can be used to identify radio link failure.

To implement the above-mentioned method, some form of SON management functionality has to be incorporated into the network. Where this resides is unimportant for understanding the invention, but for convenience we may assume that there is a SON server attached to the network at a relatively high level. This will typically be a general-purpose computer executing a SON algorithm. Alternatively the SON functionality may be distributed among the eNodeBs (and/or among so-called Mobility Management Entities, MMEs, which control the eNodeBs) for example. Thus, assuming that a distinct SON server is provided, the results of the collecting are sent by the eNodeBs to the SON server, the varying of the hysteresis and/or offsets is performed by the SON server instructing the eNodeBs, and the observing of the effects, and the distinguishing of coverage hole from pure-HO issues, are performed by the SON server.

Various modifications are possible within the scope of the present invention.

Although the above description refers to detection of coverage holes, the present invention is broader than merely detecting coverage holes per se. For example, it may be that the existence of a coverage hole per se is already known, yet it may be desired to gauge its extent, or severity at a certain point in time. Thus, to generalise, what the present invention provides is not necessarily (or not just) detection of a coverage hole but information about a coverage hole.

Although the above detailed description has referred to an LTE wireless communication system as an example, this is not essential, and the same technique can be applied to any kind of system wherein varying hysteresis and/or offsets related to a HO decision may be expected to yield information about coverage holes. In the claims, the term “mobile stations” is intended to embrace any kind of portable subscriber stations used in wireless communication system, including mobile stations normally denoted by MS in WiMAX and UE in LTE.

Thus, to summarise, an embodiment of the present invention relies on the radio link failure (RLF) statistics provided by multiple UE reports at the handover stage. The handover point would be (slightly) different for each UE due to the differences in parameter settings and measurement values. This gives a statistical distribution of the exact handover point. In an LTE system for example, when a series of RLF is reported, the eNodeBs will change the handover parameters to remedy the issue. If RLF persists for most of the UEs even after varying hysteresis and/or offsets related to a HO decision, this invention uses it as a strong indication of a coverage hole.

### INDUSTRIAL APPLICABILITY

The present invention may be applied to improve the performance of cellular-type wireless communication networks. An advantage of the invention is that it offers automatic detection of coverage holes at cell edges without the need for UEs undergoing RLF to report their locations. At cell edge, the coverage holes can readily be confused with handover failure issues. The present invention offers a robust method of identifying coverage holes, in the absence of accurate UE location information.

What is claimed is:

1. A method of detecting coverage holes in a wireless communication network, the wireless communication network comprising a cell in which radio links are defined with a plurality of user equipments, the cell bordered by other cells at respective cell edges, the network operable to handover a said user equipment at a said cell edge when predetermined handover parameters are fulfilled to define a new radio link, the method comprising:
collecting reports indicative of radio link failure from the user equipments and identifying a specific cell edge at which such reports occur;
for user equipments at the specific cell edge, varying the handover parameters and observing the effects, if any, of said varying on the occurrence of subsequent reports indicative of radio link failure; and
distinguishing radio link failures caused by a coverage hole from radio link failures having other causes, based on the observed effects of varying the handover parameters.

2. The method according to claim 1 wherein the varying includes varying at least one of a hysteresis and an offset applied to a threshold of a parameter relating to signal strength and/or quality, the threshold triggering a measurement report from the user equipment.

3. The method according to claim 2 wherein the varying includes at least one of reducing and increasing the hysteresis and/or offset within a permissible range of values.

4. The method according to claim 2 wherein the reports indicative of radio link failure include one or more of: reports generated in response to an initiated, but unsuccessful handover which include information indicative of an event sequence related to the unsuccessful handover;
reports generated shortly before or after a successful handover, which include information indicative of an event sequence related to the successful handover; and reports related to a non-initiated handover.

5. The method according to claim 4 wherein the distinguishing comprises determining whether, for a plurality of distinct handover event sequences, related reports become more or less frequent subsequent to the varying.

6. The method according to claim 2 wherein the collecting includes one or more of: collecting hysteresis and/or offset values set in the user equipments generating reports indicative of radio link failure; and collecting measurement reports used for handover.

7. The method according to claim 2 wherein the reports indicative of radio link failure indicate the radio link failure either directly or indirectly.

8. The method according to claim 7, applied to a LTE-based network, wherein the reports indicative of radio link failure include at least one of an RLF report and an RRC Connection Reestablishment Request.

9. The method according to claim 2 wherein said parameter relating to signal strength and/or quality includes at least one of a Reference Signal Received Power, a Reference Signal Received Quality, a Received Signal Strength Indicator, and a Carrier to Interference plus Noise Ratio.

10. The method according to claim 1, applied to an LTE-based network in which the cells are provided by eNodeBs, wherein at least the collecting and the varying involve the eNodeBs.

11. The method according to claim 10 wherein the eNodeBs send the results of the collecting to a SON server in the network, the varying is performed by the SON server instructing the eNodeBs, and the observing and the distinguishing are performed by the SON server.

12. A wireless communication system arranged to perform the method according to claim 1.

13. An eNodeB for an LTE-based wireless communication network and configured for use in the method according to claim 1.

14. A SON server for use in the method according to claim 11.

15. A non-transitory computer-readable medium on which is recorded software which, when executed by a computer, configures the computer to provide the SON server according to claim 14.
